(19) United States
(12) Patent Application Publication
(10) Pub. No.: US 2015/0220924 A1
(43) Pub. Date: Aug. 6, 2015

(54) METHOD AND SYSTEM FOR LINKING A CUSTOMER IDENTITY TO A RETAIL TRANSACTION

(71) Applicant: Outsite Networks, Inc., Norfolk, VA (US)

(72) Inventor: Anton Bakker, Norfolk, VA (US)

(73) Assignee: Outsite Networks, Inc., Norfolk, VA (US)

(21) Appl. No.: 14/172,496

(22) Filed: Feb. 4, 2014

(51) Int. Cl. G06Q 20/40; G06Q 20/32; G06Q 30/02

(52) U.S. Cl. CPC G06Q 20/4014; G06Q 30/0226; G06Q 20/3224; G06Q 20/327

(57) ABSTRACT

A system, method and computer program product for linking a customer identity to a retail transaction, including a loyalty processing system receiving from a customer device a location of the device; receiving a partial credit card number from a retail transaction performed by the customer; determining if the partial credit card number matches a profile of the customer; determining if the customer is at a location of the retail transaction based on the received location, and the partial credit card number from the retail transaction matching the partial credit card number in the profile; receiving an ID number associated with the customer, and/or the customer device; authenticating the customer based on matching the received ID number with a corresponding ID number in the profile; and if the customer is at the location of the retail transaction, and authenticated, providing loyalty related services including points, rewards issuance, and/or marketing offers.

### BACKGROUND OF THE INVENTION

1. Field of the Invention

The present invention generally relates to systems and methods for processing retail transactions, and more particularly to a system and method for linking a customer identity to a retail transaction, and the like.

2. Discussion of the Background

In recent years there have been developed loyalty systems commonly used by retail locations to retain a customer base thereof by offering the customers incentives, and the like, to continue visiting the retail locations, and to spend more money. However, customer acquisition and retention often relies on additional items, such as loyalty cards, tags, and the like, and requires the customer to take action on each transaction to be properly identified, and the like.

### SUMMARY OF THE INVENTION

Therefore, there is a need for a method and system that addresses the above and other problems with conventional systems, including simplifying conventional processes to eliminate as much of the required customer interaction as possible to make it easier and automatic for both the customer and retailer to conduct transactions. For example, a large number of fuel customers do not shop in the convenience store of a gas station. Such customers typically pay at the pump with a credit card. Traditional loyalty systems often require that a second card or other identifying item be used at the fuel dispenser to link the customer to the fueling transaction. However, these additional items are easily lost, misplaced or simply discarded as being too much trouble to employ by the customers.

The above and other problems are addressed by the illustrative embodiments of the present invention, which provide a novel system and method including employing a customer's cell phone as an identifying item. Advantageously, the customer is much more likely to have such a device with them, as compared to the conventional devices. However, using a cell phone as the sole identifying item requires that the customer take physical action with the devices, such as tapping a key or otherwise interfacing the phone to the fuel dispenser, and the like. Advantageously, the illustrative system and method eliminate the need for direct consumer action by identifying the presence of the phone device at the fueling location, and linking the device to a transaction that exhibits additional partial identifying information (e.g., last four digits of a credit card, etc.), such that the combination of the phone presence, and the partial transaction information is employed to fully identify the customer with a high degree of accuracy, and wherein the customer has previously loaded a customer profile with such partial transaction information (e.g., partial credit card numbers, etc.). Accordingly, when a customer fuels at a fuel dispenser and pays with one of the registered credit cards, and also has a cell phone in the vicinity (e.g., in the vehicle or in a pocket or purse, etc.) during the time of the transaction, the transaction can automatically be linked to the customer's profile, and the like.

Accordingly, in illustrative aspects of the present invention there is provided a system, method and computer program product for linking a customer identity to a retail transaction, including a loyalty processing system receiving from a customer device a location of the device; receiving a partial credit card number from a retail transaction performed by the customer; determining if the partial credit card number matches a profile of the customer; determining if the customer is at a location of the retail transaction based on the received location, and the partial credit card number from the retail transaction matching the partial credit card number in the profile; receiving an ID number associated with the customer, and/or the customer device; authenticating the customer based on matching the received ID number with a corresponding ID number in the profile; and if the customer is at the location of the retail transaction, and authenticated, providing loyalty related services including points, rewards issuance, and/or marketing offers.

The device of the customer communicates its position to the loyalty processing system by sending Global Position System (GPS) coordinates from a GPS receiver in the device of the customer.

The device of the customer communicates its position to the loyalty processing system by using a Bluetooth Low Energy (BLE) device of the device of the customer to communicate with a BLE device at the location of the retail transaction that is in communication with the loyalty processing system, and the loyalty processing system receives a unique BLE identification (ID) from the BLE device at the location of the retail transaction and matches the BLE device ID to a known location to determine that the customer is at the location of the retail transaction performed by the customer.

The device of the customer communicates its position to the loyalty processing system by using a near field communications (NFC) device including a Bluetooth device, an RFID device, 802.11 based device, and a Zigbee device of the cell phone to communicate with a corresponding device at the location of the retail transaction that is in communication with the loyalty processing system, and the loyalty processing system receives a unique identification (ID) from the NFC device at the location of the retail transaction and matches the NFC device ID to a known location to determine that the customer is at the location of the retail transaction performed by the customer.

The device at the location of the retail transaction captures the partial credit card number of the retail transaction, and includes at least one of a printer device, a journal device, a Digital Video Recorder (DVR), a Security Camera, and a Back Office interface device at the location of the retail transaction.

The device of the customer device includes one of a cell phone device, a smart vehicle system, an iPad device, an iPod device, an Android tablet, and an intelligent personal device.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative linking system, for example, utilizing global positioning systems (GPS) technology, and the like, resident in a cell phone, and the like;

FIG. 2 is an illustrative linking system utilizing Bluetooth Low Energy (BLE) devices;

FIG. 3 is an illustrative flowchart corresponding to the illustrative linking systems of FIGS. 1-2;

FIG. 4 is an illustrative flowchart corresponding to the illustrative linking system of FIG. 1; and

FIG. 5 is an illustrative alternative flowchart corresponding to the illustrative linking system of FIG. 2.

### DETAILED DESCRIPTION OF THE PREFERRED EMBODIMENTS

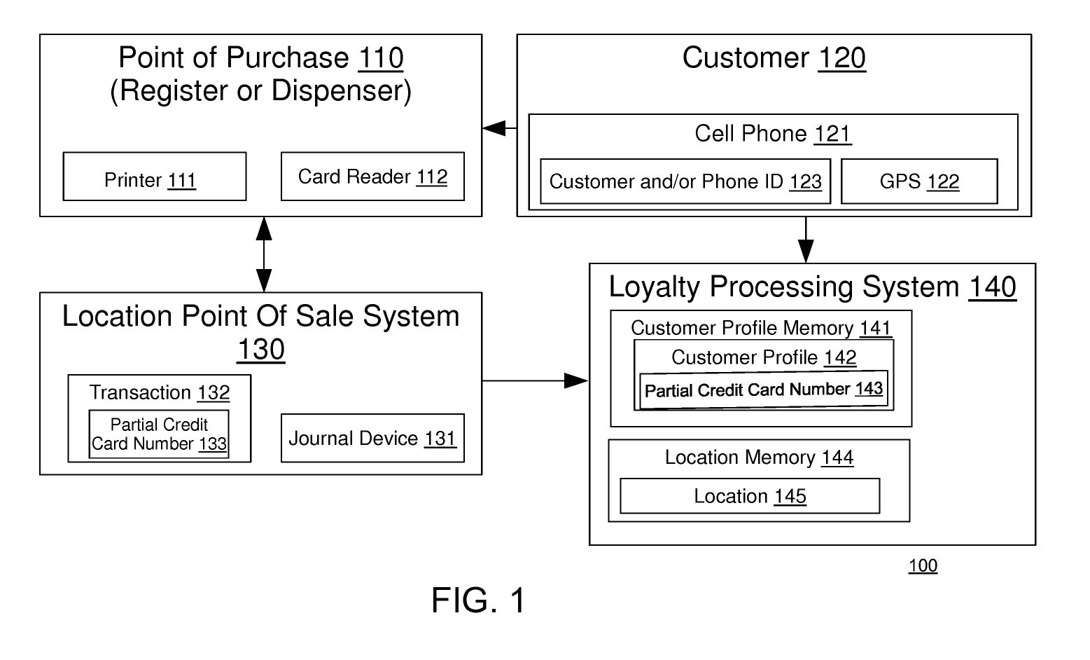

Referring now to the drawings, wherein like reference numerals designate identical or corresponding parts throughout the several views, and more particularly to FIG. 1 thereof, there shown an illustrative linking system 100, for example, utilizing global positioning systems (GPS) technology, and the like, resident in a cell phone, and the like. In FIG. 1, the system 100 includes a loyalty processing system 140 that is illustrated as a single item for simplicity, but can include multiple components with some at the physical location and some at a remote location and with appropriate communications technologies to allow the components to act together as a whole. The loyalty processing system 140 obtains a transaction 132 from either a journal device 131 attached at a location of a point of sale system 130 or a printer 111 attached to a point of purchase register or dispenser 110. The loyalty processing system 140 examines the transaction 132 for a partial credit card number 133, and the like, reflecting the use of a credit card for payment through a card reader 112 at the point of purchase 110.

The system 100 also includes a customer 120 that has a cell phone 121 with global positioning system (GPS) 122, and the like, along with a customer and/or phone identification (ID) 123. When employing the GPS 122, the cell phone 121 determines that it is within some distance of the linking system 100, as determined in conjunction with the loyalty processing system 140, which includes a location memory 144 to determine if the cell phone 121 is at a known location 145. The cell phone 121 communicates the customer and/or phone ID 123 to the loyalty processing system 140. The loyalty processing system 140 uses the customer and/or phone ID 123 to lookup a customer profile 142 from a customer profile memory 141. If the loyalty processing system 140 determines that the customer profile 142 includes a partial credit card number 143 that matches any of the current or recent transactions 132, it assigns the customer profile 142 to the transaction 132 and is then able to perform typical logic associated with loyalty programs, and the like, and not described in further detail for the sake of brevity.

In illustrative embodiments, the customer and/or phone ID 123 can include for identifying the cell phone 121 device, and the like, serial numbers, MAC Address(es), 802.11a/b/g/n/ac addresses, Bluetooth addresses, IMEI (International Mobil Equipment Identity) numbers, ICCID (Integrated Circuit Card Identifier) numbers, RFIDs from built in NFC devices, operating system (OS) (e.g., iOS, Android, etc.) assigned IDs, UDID (Universal Device ID), and the like. Similarly, in further illustrative embodiments, the customer and/or phone ID 123 can include for identifying the customer 120, and the like, customer phone numbers, loyalty customer ID numbers, stored loyalty card information, stored loyalty barcode information, stored RFIDs associated with loyalty tags, stored credit and debit card numbers, loyalty user credentials (e.g., username/password, etc.), customer biometric information (e.g., fingerprint, retina print, voice print, etc.)

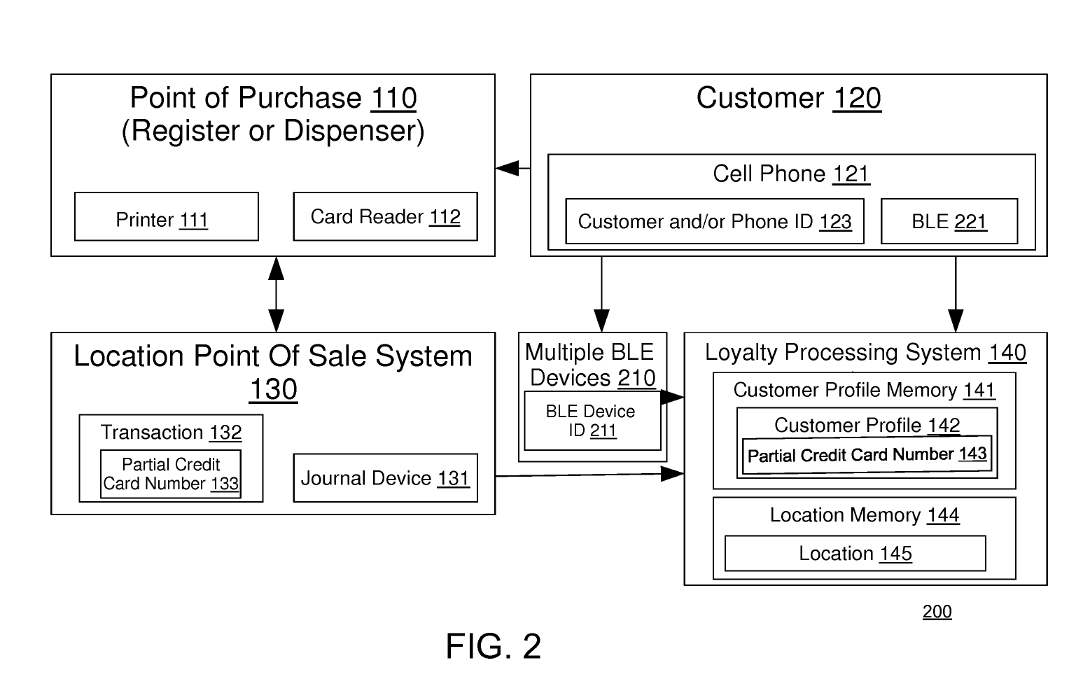

FIG. 2 is an illustrative linking system 200 utilizing Bluetooth Low Energy (BLE) devices. The system 200 can include one or more of the components from the system and method described with respect to FIG. 1, wherein the common components are not further described in detail for the sake of brevity. FIG. 2 includes BLE devices instead of or in addition to global position systems to allow the cell phone 121 to determine that it is at a given location. The cell phone 121 includes a BLE device 221 that is able to determine its proximity to one of multiple BLE devices 210 at a given location. Each BLE device making the set of BLE devices 210 include a BLE device ID 211. While the cell phone 121 is able to communicate its presence directly to the loyalty processing system 140 as in FIG. 1, it is also able to communicate between its own BLE device 121 and the location's BLE devices 210, which can then forward the customer and/or phone ID 123 along with its own BLE device ID 211 to the loyalty processing system 140.

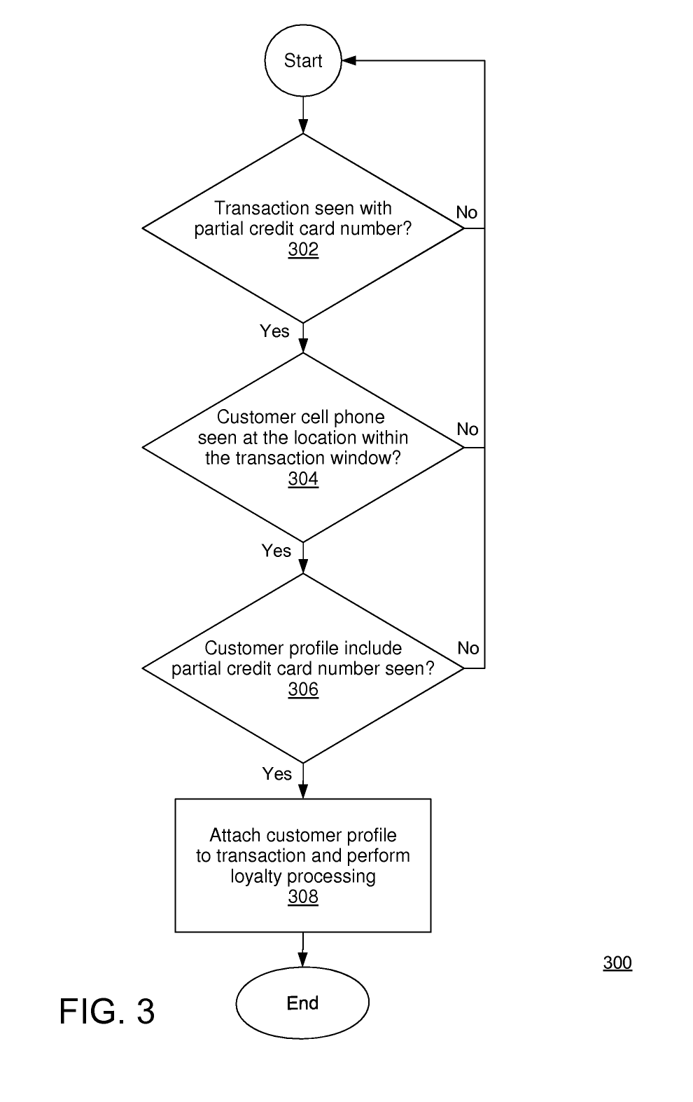

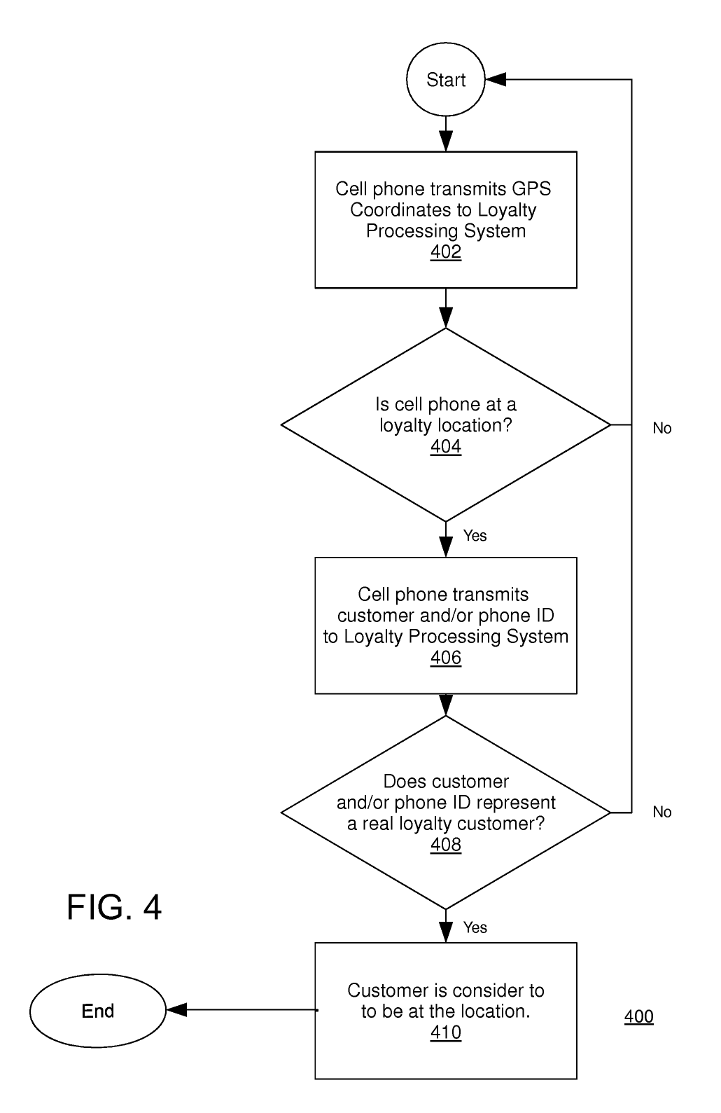

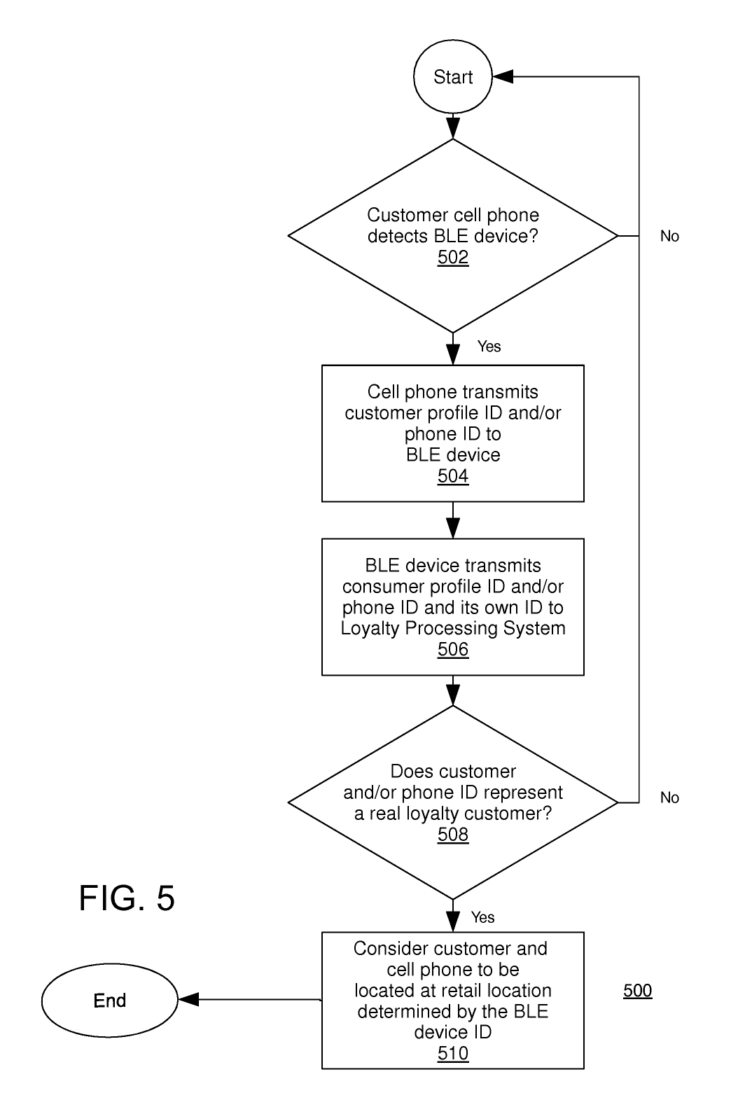

FIG. 3 is an illustrative flowchart 300 corresponding to the illustrative linking systems 100 and 200 of FIGS. 1 and 2. In FIG. 3, at step 302, the loyalty processing system 140 receives the transaction 132 from the location point of sale system 130, either from the journal device 131 or the printer 111. The loyalty processing system 140 examines the transaction 132 for the presence of the partial credit card number 133 and, if found, at step 304 the loyalty processing system 140 checks to see if the customer cell phone 121 is at the given location and has transmitted the customer and/or phone ID 123, via the operation of flowcharts in FIGS. 4 and 5, within some time frame of the transaction 132 occurring. If so, in step 306, the loyalty processing system 140 verifies that the customer profile 142, obtained via the customer and/or phone ID 123 in conjunction with the customer profile memory 141, includes the same partial credit card number 143 and, if so, in step 308, attaches the customer profile 142 and the transaction 132 together to perform loyalty processing, and the like. If any of the determining steps 302-306 fail, control returns to the start of the processing and with a suitable message, and the like, generated.

FIG. 4 is an illustrative flowchart 400 corresponding to the illustrative linking system 100 of FIG. 1. In FIG. 4, in step 402, the cell phone 121 transmits its GPS 122 coordinates to the loyalty processing system 140, which, in step 404, looks up those coordinates in the location memory 144 to determine if the cell phone 121 is at the known location 145. If so, in step 406, the cell phone 121 transmits the customer and/or phone ID 123 to the loyalty processing system 140, which, in step 408, determines by looking up the customer and/or phone ID 123 in the customer profile memory 141 if the customer and/or phone ID 123 represents a loyalty customer. If so, in step 410, the customer 120 is identified as a loyalty customer at the location 145, completing the process. If any of the determining steps 404 and 408 fail, control returns to the start of the processing and with a suitable message, and the like, generated.

FIG. 5 is an illustrative alternative flowchart 500 corresponding to the illustrative linking system 200 of FIG. 2. In FIG. 5, in step 502, the cell phone 120 looks for the BLE device 210 and, if found, in step 504, transmits the customer and/or phone ID 123 to the BLE device 210. In step 506, the BLE device 210 transmits the customer and/or phone ID 123 as well as its own BLE device ID 211 to the loyalty processing system 140. In step 508, the loyalty processing system 140 verifies that the customer and/or phone ID 123 represents a real loyalty customer and, if so, in step 510, the loyalty processing system 140 determines the current location by looking up the BLE Device ID 211 in the location memory 144 to obtain the location 145, so that the customer 120 is identified as a loyalty customer at the location 145, completing the process. If any of the determining steps 504 and 508 fail, control returns to the start of the processing and with a suitable message, and the like, generated.

Although the present invention is described in terms of employing GPS 122 and/or BLE devices 221 and 210, further illustrative embodiments can employ any suitable combination of location determining technologies, and the like, as will be appreciated by those of ordinary skill in the relevant arts, based on the present disclosure. For example, near field communications technology (e.g., Classic Bluetooth, RFID, 802.11a/b/g/n/ac, Zigbee, and the like) in lieu of a GPS or BLE device can be employed, a transaction monitoring system (e.g., Digital Video Recorder (DVR), Security Camera, Back Office interface, and the like) in lieu of the printer 111 or journal 131 monitoring can be employed, and personal smart devices (e.g., smart vehicles, iPads, iPods, Android devices, and the like) in lieu of the cell phone 121 can be employed.

The above-described devices and subsystems of the illustrative embodiments of FIGS. 1-5 can include, for example, any suitable servers, workstations, PCs, laptop computers, PDAs, Internet appliances, handheld devices, cellular telephones, wireless devices, other devices, and the like, capable of performing the processes of the illustrative embodiments of FIGS. 1-5. The devices and subsystems of the illustrative embodiments of FIGS. 1-5 can communicate with each other using any suitable protocol and can be implemented using one or more programmed computer systems or devices.

One or more interface mechanisms can be used with the illustrative embodiments of FIGS. 1-5, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the illustrative embodiments can be implemented on the World Wide Web.

It is to be understood that the devices and subsystems of the illustrative embodiments of FIGS. 1-5 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-5 can be implemented via one or more programmed computer systems or devices.

To implement such variations as well as other variations, a single computer system can be programmed to perform the special purpose functions of one or more of the devices and subsystems of the illustrative embodiments of FIGS. 1-5. On the other hand, two or more programmed computer systems or devices can be substituted for any one of the devices and subsystems of the illustrative embodiments of FIGS. 1-5. Accordingly, principles and advantages of distributed processing, such as redundancy, replication, and the like, also can be implemented, as desired, to increase the robustness and performance the devices and subsystems of the illustrative embodiments of FIGS. 1-5.

The devices and subsystems of the illustrative embodiments of FIGS. 1-5 can store information relating to various processes described herein. This information can be stored in one or more memories, such as a hard disk, optical disk, magneto-optical disk, RAM, and the like, of the devices and subsystems of the illustrative embodiments of FIGS. 1-5. One or more databases of the devices and subsystems of the illustrative embodiments of FIGS. 1-5 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-5 can include appropriate data structures for storing data collected and/or generated by the processes of the devices and subsystems of the illustrative embodiments of FIGS. 1-5 in one or more databases thereof.

All or a portion of the devices and subsystems of the illustrative embodiments of FIGS. 1-5 can be conveniently implemented using one or more general purpose computer systems, microprocessors, digital signal processors, micro-controllers, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-5 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-5, for driving the devices and subsystems of the illustrative embodiments of FIGS. 1-5, for enabling the devices and subsystems of the illustrative embodiments of FIGS. 1-5 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-5. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-5 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for linking a customer identity to a retail transaction, the system comprising:
a loyalty processing system;
the loyalty processing system configured to receive from a device of a customer a location of the device;
the loyalty processing system configured to receive a partial credit card number from a retail transaction performed by the customer;
the loyalty processing system configured to determine if the partial credit card number from the retail transaction matches a partial credit card number in a profile of the customer stored at the loyalty processing system;
the loyalty processing system configured to determine if the customer is at a location of the retail transaction performed by the customer based on the location communicated by the device of the customer, and based on the partial credit card number from the retail transaction matching the partial credit card number in the profile of the customer stored at the loyalty processing system;
the loyalty processing system configured to receive at least one of an identification (ID) number associated with the customer, and an ID number associated with the device of the customer;
the loyalty processing system configured to authenticate the customer based on matching the received ID number associated with the customer, and/or the device of the customer, with a corresponding ID number associated with the customer, and/or the device of the customer in the profile of the customer stored at the loyalty processing system; and
if the loyalty processing system determines that the customer is at the location of the retail transaction performed by the customer, and if the loyalty processing system authenticates the customer, the loyalty processing system configured to provide loyalty related services to the customer including at least one of points, rewards issuance, and marketing offers provided to the customer from a device at the location of the retail transaction based on the retail transaction.

2. The system of claim 1, wherein the device of the customer communicates its position to the loyalty processing system by sending Global Position System (GPS) coordinates from a GPS receiver in the device of the customer.

3. The system of claim 1, wherein the device of the customer communicates its position to the loyalty processing system by using a Bluetooth Low Energy (BLE) device of the device of the customer to communicate with a BLE device at the location of the retail transaction that is in communication with the loyalty processing system, and
the loyalty processing system receives a unique BLE identification (ID) from the BLE device at the location of the retail transaction and matches the BLE device ID to a known location to determine that the customer is at the location of the retail transaction performed by the customer.

4. The system of claim 1, wherein the device of the customer communicates its position to the loyalty processing system by using a near field communications (NFC) device including a Bluetooth device, an RFID device, 802.11 based device, and a Zigbee device of the cell phone to communicate with a corresponding device at the location of the retail transaction that is in communication with the loyalty processing system, and
the loyalty processing system receives a unique identification (ID) from the NFC device at the location of the retail transaction and matches the NFC device ID to a known location to determine that the customer is at the location of the retail transaction performed by the customer.

5. The system of claim 1, wherein the device at the location of the retail transaction captures the partial credit card number of the retail transaction, and includes at least one of a printer device, a journal device, a Digital Video Recorder (DVR), a Security Camera, and a Back Office interface device at the location of the retail transaction.

6. The system of claim 1, wherein the device of the customer device includes one of a cell phone device, a smart vehicle system, an iPad device, an iPod device, an Android tablet, and an intelligent personal device.

7. A method for linking a customer identity to a retail transaction, the method comprising:
receiving with a loyalty processing system from a device of a customer a location of the device;
receiving with the loyalty processing system a partial credit card number from a retail transaction performed by the customer;
determining with the loyalty processing system if the partial credit card number from the retail transaction matches a partial credit card number in a profile of the customer stored at the loyalty processing system;
determining with the loyalty processing system if the customer is at a location of the retail transaction performed by the customer based on the location communicated by the device of the customer, and based on the partial credit card number from the retail transaction matching the partial credit card number in the profile of the customer stored at the loyalty processing system;
receiving with the loyalty processing system at least one of an identification (ID) number associated with the customer, and an ID number associated with the device of the customer;
authenticating with the loyalty processing system the customer based on matching the received ID number associated with the customer, and/or the device of the customer, with a corresponding ID number associated with the customer, and/or the device of the customer in the profile of the customer stored at the loyalty processing system; and
if the loyalty processing system determines that the customer is at the location of the retail transaction performed by the customer, and if the loyalty processing system authenticates the customer, providing with the loyalty processing system loyalty related services to the customer including at least one of points, rewards issuance, and marketing offers provided to the customer from a device at the location of the retail transaction based on the retail transaction.

8. The method of claim 7, wherein the device of the customer communicates its position to the loyalty processing system by sending Global Position System (GPS) coordinates from a GPS receiver in the device of the customer.

9. The method of claim 7, wherein the device of the customer communicates its position to the loyalty processing system by using a Bluetooth Low Energy (BLE) device of the device of the customer to communicate with a BLE device at the location of the retail transaction that is in communication with the loyalty processing system, and
receiving with the loyalty processing system a unique BLE identification (ID) from the BLE device at the location of the retail transaction and matches the BLE device ID to a known location to determine that the customer is at the location of the retail transaction performed by the customer.

10. The method of claim 7, wherein the device of the customer communicates its position to the loyalty processing system by using a near field communications (NFC) device including a Bluetooth device, an RFID device, 802.11 based device, and a Zigbee device of the cell phone to communicate with a corresponding device at the location of the retail transaction that is in communication with the loyalty processing system, and
receiving with the loyalty processing system a unique identification (ID) from the NFC device at the location of the retail transaction and matches the NFC device ID to a known location to determine that the customer is at the location of the retail transaction performed by the customer.

11. The method of claim 7, wherein the device at the location of the retail transaction captures the partial credit card number of the retail transaction, and includes at least one of a printer device, a journal device, a Digital Video Recorder (DVR), a Security Camera, and a Back Office interface device at the location of the retail transaction.

12. The method of claim 7, wherein the device of the customer device includes one of a cell phone device, a smart vehicle system, an iPad device, an iPod device, an Android tablet, and an intelligent personal device.

13. A computer program product for linking a customer identity to a retail transaction, and including one or more computer readable instructions embedded on a tangible, non-transitory computer readable medium and configured to cause one or more computer processors to perform the steps of:
receiving with a loyalty processing system from a device of a customer a location of the device;
receiving with the loyalty processing system a partial credit card number from a retail transaction performed by the customer;
determining with the loyalty processing system if the partial credit card number from the retail transaction matches a partial credit card number in a profile of the customer stored at the loyalty processing system;
determining with the loyalty processing system if the customer is at a location of the retail transaction performed by the customer based on the location communicated by the device of the customer, and based on the partial credit card number from the retail transaction matching the partial credit card number in the profile of the customer stored at the loyalty processing system;
receiving with the loyalty processing system at least one of an identification (ID) number associated with the customer, and an ID number associated with the device of the customer;
authenticating with the loyalty processing system the customer based on matching the received ID number associated with the customer, and/or the device of the customer, with a corresponding ID number associated with the customer, and/or the device of the customer in the profile of the customer stored at the loyalty processing system; and
if the loyalty processing system determines that the customer is at the location of the retail transaction performed by the customer, and if the loyalty processing system authenticates the customer, providing with the loyalty processing system loyalty related services to the customer including at least one of points, rewards issuance, and marketing offers provided to the customer from a device at the location of the retail transaction based on the retail transaction.

14. The computer program product of claim 13, wherein the device of the customer communicates its position to the loyalty processing system by sending Global Position System (GPS) coordinates from a GPS receiver in the device of the customer.

15. The computer program product of claim 13, wherein the device of the customer communicates its position to the loyalty processing system by using a Bluetooth Low Energy (BLE) device of the device of the customer to communicate with a BLE device at the location of the retail transaction that is in communication with the loyalty processing system, and
receiving with the loyalty processing system a unique BLE identification (ID) from the BLE device at the location of the retail transaction and matches the BLE device ID to a known location to determine that the customer is at the location of the retail transaction performed by the customer.

16. The computer program product of claim 13, wherein the device of the customer communicates its position to the loyalty processing system by using a near field communications (NFC) device including a Bluetooth device, an RFID device, 802.11 based device, and a Zigbee device of the cell phone to communicate with a corresponding device at the location of the retail transaction that is in communication with the loyalty processing system, and
receiving with the loyalty processing system a unique identification (ID) from the NFC device at the location of the retail transaction and matches the NFC device ID to a known location to determine that the customer is at the location of the retail transaction performed by the customer.

17. The computer program product of claim 13, wherein the device at the location of the retail transaction captures the partial credit card number of the retail transaction, and includes at least one of a printer device, a journal device, a Digital Video Recorder (DVR), a Security Camera, and a Back Office interface device at the location of the retail transaction.

18. The computer program product of claim 13, wherein the device of the customer device includes one of a cell phone device, a smart vehicle system, an iPad device, an iPod device, an Android tablet, and an intelligent personal device.
